(19) United States
(12) Patent Application Publication
(10) Pub. No.: US 2016/0053205 A1
(43) Pub. Date: Feb. 25, 2016

(54) Diester Stripping Composition

(71) Applicant: Geo-Tech Polymers, LLC, Westerville, OH (US)

(72) Inventors: Kenneth J. Heater, Delaware, OH (US); Anne B. McCoppin, Powell, OH (US); Douglas R. Gels, Lewis Center, OH (US)

(21) Appl. No.: 14/830,626

(22) Filed: Aug. 19, 2015

Related U.S. Application Data
(60) Provisional application No. 62/039,218, filed on Aug. 19, 2014.

(51) Int. Cl. C11D 7/26; B08B 3/08; C09D 9/00; C11D 3/20; B29B 17/02

(52) U.S. Cl. CPC C11D 7/266; C11D 3/2093; B29B 17/02; C09D 9/00; B08B 3/08; B29B 2017/0286

(57) ABSTRACT

Compositions, process mixtures, kits, and methods are provided for removing one or more coatings from a polymeric substrate using a single-phase aqueous solution. The single-phase aqueous solution may include water and an organic ester fraction. The organic ester fraction may include one or more alkyldioic acid dialkylesters.

### CROSS-REFERENCE TO RELATED APPLICATIONS

This application claims priority to U.S. Provisional Patent Application No. 62/039,218, filed on Aug. 19, 2014, which is incorporated by reference herein in its entirety.

### BACKGROUND

Polymeric substrates, such as plastic regrind formed in recycling processes, may include undesirable coatings. For example, coatings may include inks, labels, adhesives, metallic films, and the like. It is desirable to process such polymeric substrates to remove undesired coatings prior to further uses of the substrates, such as recycled feedstocks for plastic article manufacture. Existing processes use extremely caustic solutions, high temperatures and/or pressures, or costly reagents to remove coatings.

The present application appreciates that removing coatings from polymeric substrates may be a challenging endeavor.

### SUMMARY

In one embodiment, a single-phase aqueous solution is provided. The single-phase aqueous solution may remove one or more coatings from a polymeric substrate. The single-phase aqueous solution may include at least about 90% by weight of water. The single-phase aqueous solution may include an organic ester fraction consisting essentially of one or more alkyldioic acid dialkylesters.

In another embodiment, a process mixture is provided. The process mixture may include a polymeric substrate. The polymeric substrate may include one or more coatings. The process mixture may include a single-phase aqueous solution. The single-phase aqueous solution may include water and an organic ester fraction. The organic ester fraction may include, may consist essentially of, or may consist of one or more alkyldioic acid dialkylesters.

In one embodiment, a method is provided. The method may include removing one or more coatings from a polymeric substrate using a single-phase aqueous solution. The method may include providing the single-phase aqueous solution. The single-phase aqueous solution may include water and an organic ester fraction. The organic ester fraction may include one or more alkyldioic acid dialkylesters. The method may include providing the polymeric substrate. The polymeric substrate may include one or more coatings. The method may include contacting the single-phase aqueous solution and the polymeric substrate to form a process mixture under conditions effective to remove a portion of the one or more coatings from the polymeric substrate.

In another embodiment, a kit is provided for making a single-phase aqueous solution for removing one or more coatings from a polymeric substrate. The kit may include an organic kit component including one or more alkyldioic acid dialkylesters. The kit may include instructions. The instructions may direct a user to combine the organic kit component with water to form the single-phase aqueous solution.

### BRIEF DESCRIPTION OF THE DRAWINGS

The accompanying figures, which are incorporated in and constitute a part of the specification, illustrate example methods and apparatuses, and are used merely to illustrate example embodiments.

FIG. 1 is a flow diagram describing an example method.

FIG. 2 is a block diagram of an example kit.

FIG. 3 is a table reporting results of EXAMPLE 2.

### DETAILED DESCRIPTION

The present application relates to compositions, process mixtures, methods, and kits for removing one or more coatings from a polymeric substrate, e.g., as demonstrated in EXAMPLES 1 and 2.

In various embodiments, a single-phase aqueous solution is provided. The single-phase aqueous solution may remove one or more coatings from a polymeric substrate. The single-phase aqueous solution may include at least about 90% by weight of water. The single-phase aqueous solution may include an organic ester fraction consisting essentially of one or more alkyldioic acid dialkylesters. As used herein, alkyldioic acid dialkylesters may also be referred to as dibasic esters or esters of alkyl dicarboxylic acids.

Various embodiments herein may recite the term “including,” or, in the claims, the term “comprising,” and their grammatical variants. For each such embodiment, corresponding additional embodiments are explicitly contemplated where the term “comprising” is replaced with “consisting essentially of” and “consisting of.” For example, the single-phase aqueous solution may consist essentially of: the water and the organic ester fraction. Further, for example, the single-phase aqueous solution may consist of: the water and the organic ester fraction.

In some embodiments, the organic ester fraction may include one or more alkyldioic acid dialkyl esters. In some embodiments, the organic ester fraction may include two or more alkyldioic acid dialkylesters. The organic ester fraction may consist essentially of, or may consist of, two alkyldioic acid dialkylesters. The organic ester fraction may include two alkyldioic acid dialkylesters in a weight ratio (w/w) of about one or more of: 1:10 to 1:1; 1:5 to 1:1; 3:10 to 1:1; 2:5 to 1:1; 1:2 to 1:1; 3:5 to 1:1; 7:10 to 1:1; 4:5 to 1:1; 1:10 to 4:5; 1:10 to 7:10; 1:10 to 3:5; 1:10 to 1:2; 1:10 to 2:5; 1:10 to 3:10; 1:10 to 1:5; 1:5 to 4:5; 3:10 to 7:10; or 2:5 to 3:5.

In several embodiments, an alkyldioic alkyl group of each of the one or more alkyldioic acid dialkylesters may independently be one of: C₂-C₁₀ alkyl, or C₂-C₁₀ alkyl substituted with C₁-C₄ alkyl or aryl. The alkyldioic alkyl group may be referred to as the alkylene group linking dicarboxylate units of the dibasic ester. An alkyldioic alkyl group of each of the one or more alkyldioic acid dialkylesters may independently or jointly, e.g., independently, be one of: C₂-C₈ alkyl, or C₂-C₈ alkyl substituted with C₁-C₄ alkyl. An alkyldioic alkyl group of each of the one or more alkyldioic acid dialkylesters may independently be C₂-C₅ alkyl. For example, an alkyldioic group of each of the one or more alkyldioic acid dialkylesters may independently be one or more of: ethanedioic, propanedioic, butanedioic, pentanedioic, hexanedioic, or heptanedioic.

In various embodiments, a dialkylester alkyl group of the one or more alkyldioic acid dialkylesters may independently or jointly, e.g., independently, be C₁-C₄ alkyl. Each dialkylester alkyl group of each of the one or more alkyldioic acid dialkylesters may be methyl. The organic ester fraction may include one or more of: dimethyl adipate or dimethyl glutarate. The organic ester fraction may consist essentially of, or may consist of, dimethyl adipate and dimethyl glutarate.

In various embodiments, the organic ester fraction may be characterized by a weight percent (w/w) with respect to the water of one or more of: 0.01% to 10%; 0.01% to 9%; 0.01% to 8%; 0.01% to 7%; 0.01% to 6%; 0.01% to 5%; 0.01% to 4%; 0.01% to 3%; 0.01% to 2%; 0.01% to 1%; 0.05% to 10%; 0.1% to 10%; 0.5% to 10%; 1% to 10%; 1% to 9%; 2% to 8%; 3% to 7%; 4% to 6%; and 5%, e.g., 0.01% to 10%.

In some embodiments, the single-phase aqueous solution may include a surfactant composition. The surfactant composition may include one or more of: an alkyl polyglycoside, an alkyl polyglucoside, an alkyl glycoside, an alkyl glucoside, a combination thereof, and the like. The surfactant composition may be present in the single-phase aqueous solution in a weight percentage (w/w) with respect to the water of one or more of: from about 0.01 to about 0.5, from about 0.025 to about 0.4, from about 0.05 to about 0.3, from about 0.075 to about 0.25, from about 0.1 to about 0.2, about 0.15, or a value or range of values based on any of the preceding, for example, from about 0.01% to about 0.5% or about 0.15%. Suitable alkyl polyglycoside compositions may include, for example, compositions sold under the tradename GLUCOPON®, e.g., GLUCOPON® 420UP, GLUCOPON® 425N, and the like (BASF Corporation, Florham Park, N.J.). For example, GLUCOPON® 420UP may be employed in a weight percentage of from about 0.01% to about 0.5%, e.g., about 0.15%. Suitable alkyl polyglycoside compositions may include two or more alkyl polyglycosides, for example, GLUCOPON® 420UP may include caprylyl (C8) glucoside and myristyl (C14) glucoside.

In various embodiments, the single-phase aqueous solution may include the water in a weight percent concentration (w/w) of the single-phase aqueous solution of at least about one or more of: 91%, 92%, 93%, 94%, 95%, 96%, 97%, 98%, 99%, 99.1%, 99.2%, 99.25%, 99.3%, 99.4%, 99.5%, or 99.6%.

In various embodiments, a process mixture is provided. The process mixture may include a polymeric substrate. The polymeric substrate may include one or more coatings. The process mixture may include a single-phase aqueous solution. The single-phase aqueous solution may include water and an organic ester fraction. The organic ester fraction may include, may consist essentially of, or may consist of one or more alkyldioic acid dialkylesters.

In several embodiments, the polymeric substrate may be in pieces or particulates, for example, as part of a plastic regrind, e.g., as part of a recycling process. The polymeric substrate, e.g., plastic regrind, may be in pieces or particles and may be one or more of: recycled; virgin plastic; rigid; flexible; fibrous; a fiber-reinforced resin; mixtures thereof; and the like. The polymeric substrate may include one or more of: polyethylene (PE), polypropylene (PP), polycarbonate (PC), acrylonitrile-butadiene-styrene (ABS), polycarbonate/acrylonitrile-butadiene-styrene (PC/ABS), polycarbonate/acrylonitrile-styrene-acrylate (PC/ASA), and thermoplastic olefinic polymers (TPO). The one or more coatings may include one or more of: a paint, an ink, a dye, a powder coat, a paper label, a plastic label, an adhesive, a barrier coating, a metalized coating, and a bio-coating. The bio-coating may be, for example, protein-based, oligosaccharide-based, and the like. The metalized coating may include a continuous film or metal particulates. Automotive paint coatings may be particularly suited for removal via the single-phase aqueous solutions, process mixtures, methods, and kits described herein.

In various embodiments of the process mixture, the single-phase aqueous solution may include the water in a weight percent concentration (w/w) of the single-phase aqueous solution of at least about one or more of: 90%, 91%, 92%, 93%, 94%, 95%, 96%, 97%, 98%, 99%, 99.1%, 99.2%, 99.25%, 99.3%, 99.4%, 99.5%, or 99.6%.

In various embodiments, the single-phase aqueous solution may consist essentially of, or may consist of the water and the organic ester fraction. The organic ester fraction may include, may consist essentially of, or may consist of two or more alkyldioic acid dialkylesters. The organic ester fraction including two alkyldioic acid dialkylesters in a weight ratio (w/w) of about one or more of: 1:10 to 1:1; 1:5 to 1:1; 3:10 to 1:1; 2:5 to 1:1; 1:2 to 1:1; 3:5 to 1:1; 7:10 to 1:1; 4:5 to 1:1; 1:10 to 4:5; 1:10 to 7:10; 1:10 to 3:5; 1:10 to 1:2; 1:10 to 2:5; 1:10 to 3:10; 1:10 to 1:5; 1:5 to 4:5; 3:10 to 7:10; and 2:5 to 3:5.

In various embodiments of the process mixture, an alkyldioic alkyl group of each of the one or more alkyldioic acid dialkylesters may independently be one of: C₂-C₁₀ alkyl, C₂-C₁₀ alkyl substituted with C₁-C₄ alkyl, or aryl. An alkyldioic alkyl group of each of the one or more alkyldioic acid dialkylesters may independently or jointly, e.g., independently, be one of: C₂-C₈ alkyl or C₂-C₈ alkyl substituted with C₁-C₄ alkyl. An alkyldioic alkyl group of each of the one or more alkyldioic acid dialkylesters may independently be C₂-C₅ alkyl. For example, an alkyldioic group of each of the one or more alkyldioic acid dialkylesters may independently be one or more of: ethanedioic, propanedioic, butanedioic, pentanedioic, hexanedioic, or heptanedioic.

In various embodiments of the process mixture, a dialkylester alkyl group of the one or more alkyldioic acid dialkylesters may independently or jointly, e.g., independently, be C₁-C₄ alkyl. Each dialkylester alkyl group of each of the one or more alkyldioic acid dialkylesters may be methyl (C₁). The organic ester fraction may include one or more of: dimethyl adipate or dimethyl glutarate. The organic ester fraction may consist essentially of, or may consist of, dimethyl adipate and dimethyl glutarate.

In various embodiments of the process mixture, the organic ester fraction may be present in a weight percent (w/w) with respect to the water of one or more of: 0.01% to 10%; 0.01% to 9%; 0.01% to 8%; 0.01% to 7%; 0.01% to 6%; 0.01% to 5%; 0.01% to 4%; 0.01% to 3%; 0.01% to 2%; 0.01% to 1%; 0.05% to 10%; 0.1% to 10%; 0.5% to 10%; 1% to 10%; 1% to 9%; 2% to 8%; 3% to 7%; 4% to 6%; and 5%, e.g., 0.01% to 10%.

In some embodiments, the single-phase aqueous solution may include a surfactant composition. The surfactant composition may include one or more of: an alkyl polyglycoside, an alkyl polyglucoside, an alkyl glycoside, an alkyl glucoside, a combination thereof, and the like. The surfactant composition may be present in the single-phase aqueous solution in a weight percentage (w/w) with respect to the water of one or more of: from about 0.01 to about 0.5, from about 0.025 to about 0.4, from about 0.05 to about 0.3, from about 0.075 to about 0.25, from about 0.1 to about 0.2, about 0.15, or a value or range of values based on any of the preceding, for example, from about 0.01% to about 0.5% or about 0.15%. Suitable alkyl polyglycoside compositions may include, for example, compositions sold under the tradename GLUCOPON®,e.g., GLUCOPON® 420UP, GLUCOPON® 425N, and the like (BASF Corporation, Florham Park, N.J.). For example, GLUCOPON® 420UP may be employed in a weight percentage of from about 0.01% to about 0.5%, e.g., about 0.15%. Suitable alkyl polyglycoside compositions may include two or more alkyl polyglycosides, for example, GLUCOPON® 420UP may include caprylyl (C8) glucoside and myristyl (C14) glucoside.

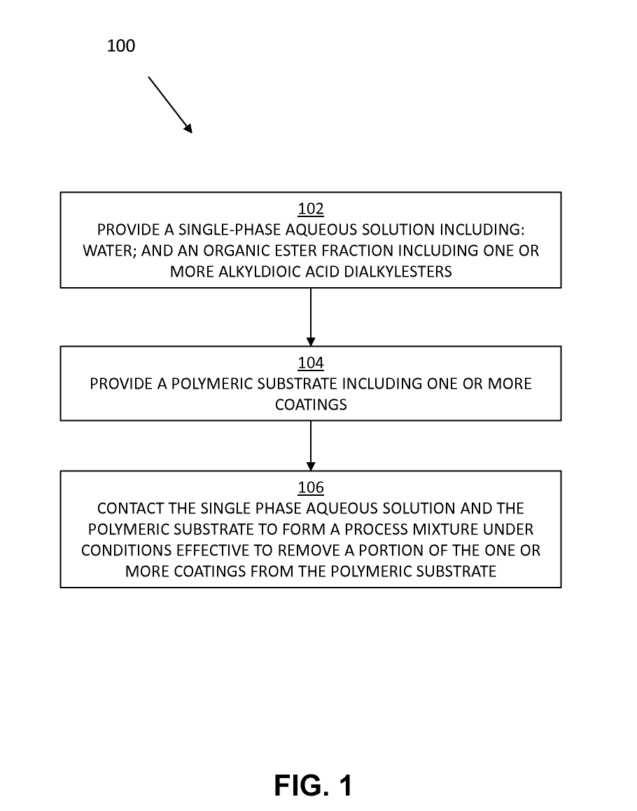

In various embodiments, a method is provided. FIG. 1 is a flow chart of an example method 100 for removing one or more coatings from a polymeric substrate using a single-phase aqueous solution. Method 100 may include 102 providing a single-phase aqueous solution. The single-phase aqueous solution may include water and an organic ester fraction. The organic ester fraction may include one or more alkyldioic acid dialkylesters. Method 100 may include 104 providing a polymeric substrate. The polymeric substrate may include one or more coatings. Method 100 may include 106 contacting the single-phase aqueous solution and the polymeric substrate to form a process mixture under conditions effective to remove a portion of the one or more coatings from the polymeric substrate.

In several embodiments of the method, the polymeric substrate may be in pieces or particulates, for example, as part of a plastic regrind, e.g., as part of a recycling process. The polymeric substrate, e.g., plastic regrind, may be in pieces or particles and may be one or more of: recycled; virgin plastic; rigid; flexible; fibrous; a fiber-reinforced resin; mixtures thereof; and the like. The polymeric substrate may include one or more of: polyethylene (PE), polypropylene (PP), polycarbonate (PC), acrylonitrile-butadiene-styrene (ABS), polycarbonate/acrylonitrile-butadiene-styrene (PC/ABS), polycarbonate/acrylonitrile-styrene-acrylate (PC/ASA), and thermoplastic olefinic polymers (TPO). The one or more coatings may include one or more of: a paint, an ink, a dye, a powder coat, a paper label, a plastic label, an adhesive, a barrier coating, a metalized coating or a bio-coating. The bio-coating may be, for example, protein-based, oligosaccharide-based, and the like. The metalized coating may include a continuous film or metal particulates.

In various embodiments, the conditions effective to remove a portion of the one or more coatings from the polymeric substrate may include at least one of: heating the process mixture, agitating the process mixture, recovering the polymeric substrate after removal of a portion of the one or more coatings, or recovering at least a portion of the single-phase aqueous solution. The contacting the single-phase aqueous solution and the polymeric substrate to form a process mixture under conditions effective to remove a portion of the one or more coatings from the polymeric substrate including one or more of: batch operating and continuous operating. The conditions effective to remove a portion of the one or more coatings from the polymeric substrate may include heating the process mixture, for example, at a temperature of about one or more of: between about 60° C. and about 100° C.; 65° C. and about 100° C.; between about 70° C. and about 100° C.; between about 75° C. and about 95° C.; between about 80° C. and about 90° C.; between about 80° C. and about 85° C.; about 85° C.; about 82° C.; or between about any two of the preceding values, or about any of the preceding values, for example, between about 60° C. and about 100° C. or about 85° C.

In various embodiments, the method may include one or more of: determining an initial coating amount; heating and agitating the process mixture; determining a process coating amount that is less than about a percentage of the initial coating amount; and recovering the polymeric substrate upon determining the process coating amount is less than about the percentage of the initial coating amount. The percentage of the initial coating amount may be, for example, one or more of about: 20%, 15%, 14%, 13%, 12%, 11%, 10%, 9%, 8%, 7%, 6%, 5%, 4%, 3%, 2%, and 1%.

In various embodiments, the method may include recovering the polymeric substrate after removal of the portion of the one or more coatings. The method may include recovering at least a portion of the single-phase aqueous solution after removal of the portion of the one or more coatings.

In various embodiments of the method, providing the single-phase aqueous solution may include providing the organic ester fraction including the one or more alkyldioic acid dialkylesters in a weight percent (w/w) with respect to the water to form the single-phase aqueous solution. The weight percent may be one or more of: 0.01% to 10%; 0.01% to 9%; 0.01% to 8%; 0.01% to 7%; 0.01% to 6%; 0.01% to 5%; 0.01% to 4%; 0.01% to 3%; 0.01% to 2%; 0.01% to 1%; 0.05% to 10%; 0.1% to 10%; 0.5% to 10%; 1% to 10%; 1% to 9%; 2% to 8%; 3% to 7%; 4% to 6%; and 5%, e.g., 0.01% to 10%. The single-phase aqueous solution may be prepared consisting essentially of, or consisting of, the water and the organic ester fraction.

In various embodiments of the method, the single-phase aqueous solution may include the water in a weight percent concentration (w/w) of the single-phase aqueous solution of at least about one or more of: 90%, 91%, 92%, 93%, 94%, 95%, 96%, 97%, 98%, 99%, 99.1%, 99.2%, 99.25%, 99.3%, 99.4%, 99.5%, and 99.6%.

In various embodiments of the method, the single-phase aqueous solution may be prepared consisting essentially of, or consisting of, the water and the organic ester fraction. The organic ester fraction may include, may consist essentially of, or may consist of two or more alkyldioic acid dialkylesters. The organic ester fraction including two alkyldioic acid dialkylesters in a weight ratio (w/w) of about one or more of: 1:10 to 1:1; 1:5 to 1:1; 3:10 to 1:1; 2:5 to 1:1; 1:2 to 1:1; 3:5 to 1:1; 7:10 to 1:1; 4:5 to 1:1; 1:10 to 4:5; 1:10 to 7:10; 1:10 to 3:5; 1:10 to 1:2; 1:10 to 2:5; 1:10 to 3:10; 1:10 to 1:5; 1:5 to 4:5; 3:10 to 7:10; and 2:5 to 3:5.

In various embodiments of the method, an alkyldioic alkyl group of each of the one or more alkyldioic acid dialkylesters may independently be one of: C₂-C₁₀ alkyl, C₂-C₁₀ alkyl substituted with C₁-C₄ alkyl, or aryl. An alkyldioic alkyl group of each of the one or more alkyldioic acid dialkylesters may independently or jointly, e.g., independently, be one of: C₂-C₈ alkyl or C₂-C₈ alkyl substituted with C₁-C₄ alkyl. An alkyldioic alkyl group of each of the one or more alkyldioic acid dialkylesters may independently be C₂-C₅ alkyl. For example, an alkyldioic group of each of the one or more alkyldioic acid dialkylesters may independently be one or more of: ethanedioic, propanedioic, butanedioic, pentanedioic, hexanedioic, and heptanedioic.

In various embodiments of the method, a dialkylester alkyl group of the one or more alkyldioic acid dialkylesters may independently or jointly, e.g., independently, be C₁-C₄ alkyl. Each dialkylester alkyl group of each of the one or more alkyldioic acid dialkylesters may be methyl. The organic ester fraction may include one or more of: dimethyl adipate or dimethyl glutarate. The organic ester fraction may consist essentially of, or may consist of, dimethyl adipate and dimethyl glutarate.

In some embodiments of the method, the single-phase aqueous solution may include a surfactant composition. The surfactant composition may include one or more of: an alkyl polyglycoside, an alkyl polyglucoside, an alkyl glycoside, an alkyl glucoside, a combination thereof, and the like. The surfactant composition may be present in the single-phase aqueous solution in a weight percentage (w/w) with respect to the water of one or more of: from about 0.01 to about 0.5, from about 0.025 to about 0.4, from about 0.05 to about 0.3, from about 0.075 to about 0.25, from about 0.1 to about 0.2, about 0.15, or a value or range of values based on any of the preceding, for example, from about 0.01% to about 0.5% or about 0.15%. Suitable alkyl polyglycoside compositions may include, for example, compositions sold under the tradename GLUCOPON®, e.g., GLUCOPON® 420UP, GLUCOPON® 425N, and the like. (BASF Corporation, Florham Park, N.J.). For example, GLUCOPON® 420UP may be employed in a weight percentage of from about 0.01% to about 0.5%, e.g., about 0.15%. Suitable alkyl polyglycoside compositions may include two or more alkyl polyglycosides, for example, GLUCOPON® 420UP may include caprylyl (C8) glucoside and myristyl (C14) glucoside.

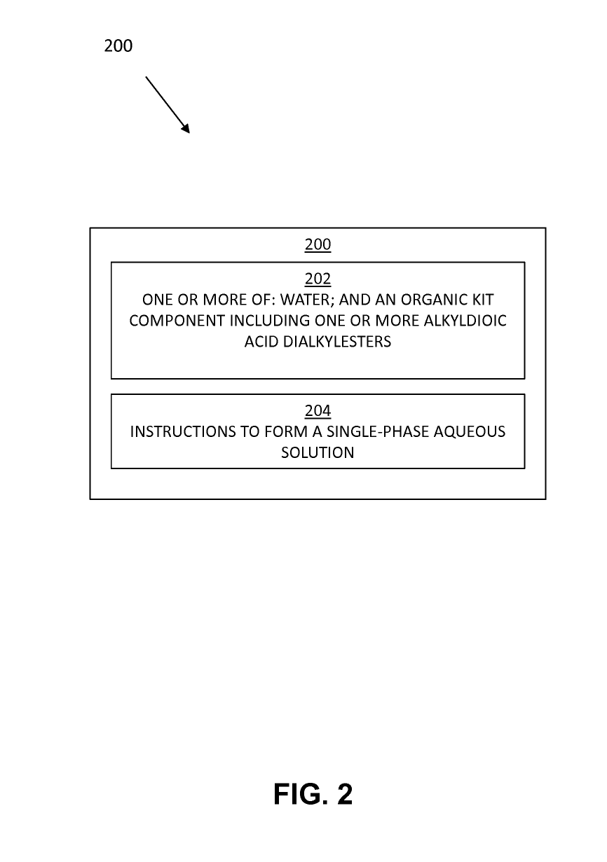

In various embodiments, a kit is provided. FIG. 2 is a block diagram of an example kit 200 for making a single-phase aqueous solution for removing one or more coatings from a polymeric substrate. Kit 200 may include an organic kit component 202 including one or more alkyldioic acid dialkylesters. Kit 200 may include instructions 204. The instructions may direct a user to combine the organic kit component with water to form the single-phase aqueous solution.

In various embodiments, the instructions may direct the user to use the polymeric substrate including one or more of: polyethylene (PE), polypropylene (PP), polycarbonate (PC), acrylonitrile-butadiene-styrene (ABS), polycarbonate/acrylonitrile-butadiene-styrene (PC/ABS), polycarbonate/acrylonitrile-styrene-acrylate (PC/ASA), and thermoplastic olefinic polymers (TPO). The instructions may direct the user to polymeric substrates coated with one or more of: a paint, an ink, a dye, a powder coat, a paper label, a plastic label, an adhesive, a barrier coating, a metalized coating or a bio-coating.

In various embodiments, the instructions may direct the user to remove the one or more coatings from the polymeric substrate including at least one of: heating the process mixture, agitating the process mixture, recovering the polymeric substrate after removal of a portion of the one or more coatings, or recovering at least a portion of the single-phase aqueous solution.

In various embodiments, the instructions may direct the user to remove the one or more coatings from the polymeric substrate including the one or more coatings by one of: batch operation or continuous operation. The instructions may direct the user to remove the one or more coatings from the polymeric substrate by heating the process mixture, e.g., at a temperature of about one or more of: between about 60° C. and about 100° C.; 65° C. and about 100° C.; between about 70° C. and about 100° C.; between about 75° C. and about 95° C.; between about 80° C. and about 90° C.; between about 80° C. and about 85° C.; about 85° C.; about 82° C.; or between about any two of the preceding values, or about any of the preceding values, for example, between about 60° C. and about 100° C. or about 85° C.

In various embodiments, the instructions may direct the user to remove the one or more coatings from the polymeric substrate by one or more of: determining an initial coating amount; heating and agitating the process mixture; determining a process coating amount that is less than about a percentage of the initial coating amount; and recovering the polymeric substrate upon determining the process coating amount is less than about the percentage of the initial coating amount. The percentage of the initial coating amount may be one or more of about: 20%, 15%, 14%, 13%, 12%, 11%, 10%, 9%, 8%, 7%, 6%, 5%, 4%, 3%, 2%, and 1%.

In various embodiments, the instructions may direct the user to combine the organic kit component in a weight percent (w/w) with respect to the water to form the single-phase aqueous solution. The weight percent may be one or more of: 0.01% to 10%; 0.01% to 9%; 0.01% to 8%; 0.01% to 7%; 0.01% to 6%; 0.01% to 5%; 0.01% to 4%; 0.01% to 3%; 0.01% to 2%; 0.01% to 1%; 0.05% to 10%; 0.1% to 10%; 0.5% to 10%; 1% to 10%; 1% to 9%; 2% to 8%; 3% to 7%; 4% to 6%; and 5%, e.g., 0.01% to 10%.

In various embodiments, organic kit component 202 may consist essentially of, or may consist of, one or more alkyldioic acid dialkylesters. Organic kit component 202 may include, may consist essentially of, or may consist of, two or more alkyldioic acid dialkylesters. Organic kit component 202 may one of: a neat mixture; an aqueous concentrate; or the single-phase aqueous solution, e.g., as a ready-to-use preparation. Organic kit component 202 may include two alkyldioic acid dialkylesters in a weight ratio (w/w) of about one or more of: 1:10 to 1:1; 1:5 to 1:1; 3:10 to 1:1; 2:5 to 1:1; 1:2 to 1:1; 3:5 to 1:1; 7:10 to 1:1; 4:5 to 1:1; 1:10 to 4:5; 1:10 to 7:10; 1:10 to 3:5; 1:10 to 1:2; 1:10 to 2:5; 1:10 to 3:10; 1:10 to 1:5; 1:5 to 4:5; 3:10 to 7:10; and 2:5 to 3:5.

In various embodiments of the process mixture, the single-phase aqueous solution may include the water in a weight percent concentration (w/w) of the single-phase aqueous solution of at least about one or more of: 90%, 91%, 92%, 93%, 94%, 95%, 96%, 97%, 98%, 99%, 99.1%, 99.2%, 99.25%, 99.3%, 99.4%, 99.5%, or 99.6%.

In various embodiments of organic kit component 202, an alkyldioic alkyl group of each of the one or more alkyldioic acid dialkylesters may independently be one of: C₂-C₁₀ alkyl, C₂-C₁₀ alkyl substituted with C₁-C₄ alkyl, or aryl. An alkyldioic alkyl group of each of the one or more alkyldioic acid dialkylesters may independently or jointly, e.g., independently, be one of: C₂-C₈ alkyl or C₂-C₈ alkyl substituted with C₁-C₄ alkyl. An alkyldioic alkyl group of each of the one or more alkyldioic acid dialkylesters may independently be C₂-C₅ alkyl. For example, an alkyldioic group of each of the one or more alkyldioic acid dialkylesters may independently be one or more of: ethanedioic, propanedioic, butanedioic, pentanedioic, hexanedioic, or heptanedioic.

In various embodiments of organic kit component 202, a dialkylester alkyl group of the one or more alkyldioic acid dialkylesters may independently or jointly, e.g., independently, be C₁-C₄ alkyl. Each dialkylester alkyl group of each of the one or more alkyldioic acid dialkylesters may be methyl. The organic ester fraction may include one or more of: dimethyl adipate or dimethyl glutarate. The organic ester fraction may consist essentially of, or may consist of, dimethyl adipate and dimethyl glutarate.

In some embodiments, the organic kit component 202 may include a surfactant composition. The surfactant composition may include one or more of: an alkyl polyglycoside, an alkyl polyglucoside, an alkyl glycoside, an alkyl glucoside, a combination thereof, and the like. The surfactant composition may be present in the single-phase aqueous solution in a weight percentage (w/w) with respect to the water of one or more of: from about 0.01 to about 0.5, from about 0.025 to about 0.4, from about 0.05 to about 0.3, from about 0.075 to about 0.25, from about 0.1 to about 0.2, about 0.15, or a value or range of values based on any of the preceding, for example, from about 0.01% to about 0.5% or about 0.15%. Suitable alkyl polyglycoside compositions may include, for example, compositions sold under the tradename GLUCOPON®,e.g., GLUCOPON® 420UP, GLUCOPON® 425N, and the like. (BASF Corporation, Florham Park, N.J.). For example, GLUCOPON® 420UP may be employed in a weight percentage of from about 0.01% to about 0.5%, e.g., about 0.15%. Suitable alkyl polyglycoside compositions may include two or more alkyl polyglycosides, for example, GLUCOPON® 420UP may include caprylyl (C8) glucoside and myristyl (C14) glucoside.

### EXAMPLES

### Example 1

About 11,793 kg of water was added to a mixing tank and heated to approximately 85 ° C. About 499 kg of a rigid plastic regrind, approximately 0.953 cm mesh size and including an automotive paint coating, was added to the water to create a slurry. The initial amount of paint coating was determined. About 590 kg of a dibasic ester mixture including dimethyl adipate and dimethyl glutarate (DBE-3, DBE® esters, INVISTA™, Kennesaw Ga.) was then added. The mixture was stirred and continued heating at 85° C. The mixture was monitored until about 98% of the initial amount of paint coating was removed. The slurry was then dewatered, rinsed and dried using conventional techniques. The washed flake was separated from the unwanted products and collected for further use or recycling. The aqueous dibasic ester solution was recovered and filtered, and was found suitable for re-use, e.g., by adding to successive batches. The dibasic ester solution of this example removed the coatings from the substrates faster than water alone; was determined to be environmentally benign at the concentrations used; and was able to be economically recycled for re-use.

### Example 2

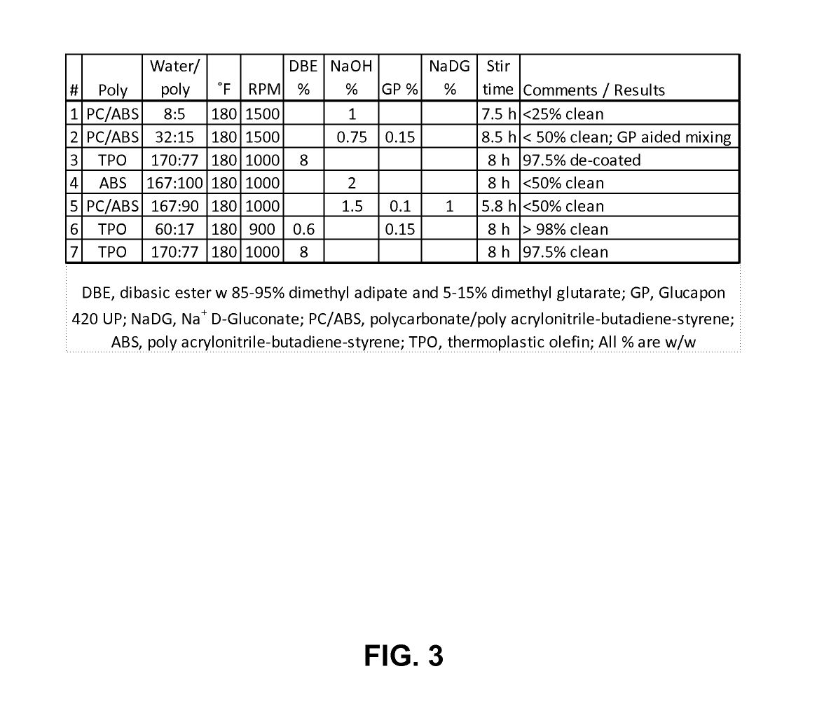

The details of various polymer substrates, stripping compositions, reaction parameters, and results of several trials conducted according to EXAMPLE 2 are shown in FIG. 3. A sample procedure follows.

About 5.44 kg of water was added to a mixing tank and heated to approximately 82° C. About 1.54 kg of a thermoplastic olefinic polymer material was added to the water and the mixture was stirred at about 900 RPM. About 0.60% (w/w) of a dibasic ester mixture including dimethyl adipate and dimethyl glutarate (DBE-3, DBE® esters, INVISTA™, Kennesaw Ga.), and 0.15% (w/w) GLUCOPON® 420UP (BASF Corporation, Florham Park, N.J.) was then added. After 8 h, the thermoplastic olefinic polymer material was determined to be >98% clean.

As can be seen in the table shown in FIG. 3, the best results were obtained upon using the indicated amounts of the dibasic ester mixture, either alone or in combination with an alkylglycoside composition such as GLUCOPON® 420UP.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See Bryan A. Garner, A Dictionary of Modern Legal Usage 624 (2d. Ed. 1995). Also, to the extent that the terms “in” or “into” are used in the specification or the claims, it is intended to additionally mean “on” or “onto.” To the extent that the term “selectively” is used in the specification or the claims, it is intended to refer to a condition of a component wherein a user of the apparatus may activate or deactivate the feature or function of the component as is necessary or desired in use of the apparatus. To the extent that the terms “operatively coupled” or “operatively connected” are used in the specification or the claims, it is intended to mean that the identified components are connected in a way to perform a designated function. To the extent that the term “substantially” is used in the specification or the claims, it is intended to mean that the identified components have the relation or qualities indicated with degree of error as would be acceptable in the subject industry.

As used in the specification and the claims, the singular forms “a,” “an,” and “the” include the plural unless the singular is expressly specified. For example, reference to “a compound” may include a mixture of two or more compounds, as well as a single compound.

As used herein, the term “about” in conjunction with a number is intended to include ±10% of the number. In other words, “about 10” may mean from 9 to 11.

As used herein, the terms “optional” and “optionally” mean that the subsequently described circumstance may or may not occur, so that the description includes instances where the circumstance occurs and instances where it does not.

As stated above, while the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art, having the benefit of the present application. Therefore, the application, in its broader aspects, is not limited to the specific details, illustrative examples shown, or any apparatus referred to. Departures may be made from such details, examples, and apparatuses without departing from the spirit or scope of the general inventive concept.

As used herein, “substituted” refers to an organic group as defined below (e.g., an alkyl group) in which one or more bonds to a hydrogen atom contained therein may be replaced by a bond to non-hydrogen or non-carbon atoms. Substituted groups also include groups in which one or more bonds to a carbon(s) or hydrogen(s) atom may be replaced by one or more bonds, including double or triple bonds, to a heteroatom. A substituted group may be substituted with one or more substituents, unless otherwise specified. In some embodiments, a substituted group may be substituted with 1, 2, 3, 4, 5, or 6 substituents. Examples of substituent groups include: halogens (i.e., F, Cl, Br, and I); hydroxyls; alkoxy, alkenoxy, aryloxy, aralkyloxy, heterocyclyloxy, and heterocyclylalkoxy groups; carbonyls (oxo); carboxyls; esters; urethanes; oximes; hydroxylamines; alkoxyamines; aralkoxyamines; thiols; sulfides; sulfoxides; sulfones; sulfonyls; sulfonamides; amines; N-oxides; hydrazines; hydrazides; hydrazones; azides; amides; ureas; amidines; guanidines; enamines; imides; isocyanates; isothiocyanates; cyanates; thiocyanates; imines; nitro groups; or nitriles (i.e., CN). A “per”-substituted compound or group is a compound or group having all or substantially all substitutable positions substituted with the indicated substituent. For example, 1,6-diiodo perfluoro hexane indicates a compound of formula C₆F₁₂I₂, where all the substitutable hydrogens have been replaced with fluorine atoms.

Substituted ring groups such as substituted cycloalkyl, aryl, heterocyclyl and heteroaryl groups also include rings and ring systems in which a bond to a hydrogen atom may be replaced with a bond to a carbon atom. Substituted cycloalkyl, aryl, heterocyclyl and heteroaryl groups may also be substituted with substituted or unsubstituted alkyl, alkenyl, and alkynyl groups as defined below.

Alkyl groups include straight chain and branched chain alkyl groups having from 1 to 12 carbon atoms, and typically from 1 to 10 carbons or, in some examples, from 1 to 8, 1 to 6, or 1 to 4 carbon atoms. Examples of straight chain alkyl groups include groups such as methyl, ethyl, n-propyl, n-butyl, n-pentyl, n-hexyl, n-heptyl, and n-octyl groups. Examples of branched alkyl groups include, but are not limited to, isopropyl, iso-butyl, sec-butyl, tent-butyl, neopentyl, isopentyl, and 2,2-dimethylpropyl groups. Representative substituted alkyl groups may be substituted one or more times with substituents such as those listed above and include, without limitation, haloalkyl (e.g., trifluoromethyl), hydroxyalkyl, thioalkyl, aminoalkyl, alkylaminoalkyl, dialkylaminoalkyl, alkoxyalkyl, or carboxyalkyl.

Cycloalkyl groups include mono-, bi- or tricyclic alkyl groups having from 3 to 12 carbon atoms in the ring(s), or, in some embodiments, 3 to 10, 3 to 8, or 3 to 4, 5, or 6 carbon atoms. Exemplary monocyclic cycloalkyl groups include, but are not limited to, cyclopropyl, cyclobutyl, cyclopentyl, cyclohexyl, cycloheptyl, and cyclooctyl groups. In some embodiments, the cycloalkyl group has 3 to 8 ring members, whereas in other embodiments, the number of ring carbon atoms ranges from 3 to 5, 3 to 6, or 3 to 7. Bi- and tricyclic ring systems include both bridged cycloalkyl groups and fused rings, such as, but not limited to, bicyclo[2.1.1]hexane, adamantyl, or decalinyl. Substituted cycloalkyl groups may be substituted one or more times with non-hydrogen and non-carbon groups as defined above. However, substituted cycloalkyl groups also include rings that may be substituted with straight or branched chain alkyl groups as defined above. Representative substituted cycloalkyl groups may be mono-substituted or substituted more than once, such as, but not limited to, 2,2-, 2,3-, 2,4-2,5- or 2,6-disubstituted cyclohexyl groups, which may be substituted with substituents such as those listed above.

Aryl groups may be cyclic aromatic hydrocarbons that do not contain heteroatoms. Aryl groups herein include monocyclic, bicyclic and tricyclic ring systems. Aryl groups include, but are not limited to, phenyl, azulenyl, heptalenyl, biphenyl, fluorenyl, phenanthrenyl, anthracenyl, indenyl, indanyl, pentalenyl, and naphthyl groups. In some embodiments, aryl groups contain 6-14 carbons, and in others from 6 to 12 or even 6-10 carbon atoms in the ring portions of the groups. In some embodiments, the aryl groups may be phenyl or naphthyl. Although the phrase “aryl groups” may include groups containing fused rings, such as fused aromatic-aliphatic ring systems (e.g., indanyl or tetrahydronaphthyl), “aryl groups” does not include aryl groups that have other groups, such as alkyl or halo groups, bonded to one of the ring members. Rather, groups such as tolyl may be referred to as substituted aryl groups. Representative substituted aryl groups may be mono-substituted or substituted more than once. For example, monosubstituted aryl groups include, but are not limited to, 2-, 3-, 4-, 5-, or 6-substituted phenyl or naphthyl, which may be substituted with substituents such as those above.

Aralkyl groups may be alkyl groups as defined above in which a hydrogen or carbon bond of an alkyl group may be replaced with a bond to an aryl group as defined above. In some embodiments, aralkyl groups contain 7 to 16 carbon atoms, 7 to 14 carbon atoms, or 7 to 10 carbon atoms. Substituted aralkyl groups may be substituted at the alkyl, the aryl or both the alkyl and aryl portions of the group. Representative aralkyl groups include but are not limited to benzyl and phenethyl groups and fused (cycloalkylaryl)alkyl groups such as 4-indanylethyl. Substituted aralkyls may be substituted one or more times with substituents as listed above.

Groups described herein having two or more points of attachment (i.e., divalent, trivalent, or polyvalent) within the compound of the technology may be designated by use of the suffix, “ene.” For example, divalent alkyl groups may be alkylene groups, divalent aryl groups may be arylene groups, divalent heteroaryl groups may be heteroarylene groups, and so forth. In particular, certain polymers may be described by use of the suffix “ene” in conjunction with a term describing the polymer repeat unit.

Alkoxy groups may be hydroxyl groups (—OH) in which the bond to the hydrogen atom may be replaced by a bond to a carbon atom of a substituted or unsubstituted alkyl group as defined above. Examples of linear alkoxy groups include, but are not limited to, methoxy, ethoxy, propoxy, butoxy, pentoxy, or hexoxy. Examples of branched alkoxy groups include, but are not limited to, isopropoxy, sec-butoxy, tent-butoxy, isopentoxy, or isohexoxy. Examples of cycloalkoxy groups include, but are not limited to, cyclopropyloxy, cyclobutyloxy, cyclopentyloxy, or cyclohexyloxy. Representative substituted alkoxy groups may be substituted one or more times with substituents such as those listed above.

The various aspects and embodiments disclosed herein are for purposes of illustration and are not intended to be limiting, with the true scope and spirit being indicated by the following claims.

1. A single-phase aqueous solution for removing one or more coatings from a polymeric substrate, comprising:
at least about 90% by weight of water; and
an organic ester fraction consisting essentially of one or more alkyldioic acid dialkylesters.

2. The single-phase aqueous solution of claim 1, an alkyldioic alkyl group of each of the one or more alkyldioic acid dialkylesters independently being one of: C₂-C₁₀ alkyl, C₂-C₁₀ alkyl substituted with C₁-C₄ alkyl or aryl, C₂-C₈ alkyl, C₂-C₈ alkyl substituted with C₁-C₄ alkyl, or C₂-C₅ alkyl.

3. The single-phase aqueous solution of claim 1, each dialkylester alkyl group of the one or more alkyldioic acid dialkylesters independently being C₁-C₄ alkyl.

4. The single-phase aqueous solution of claim 1, the organic ester fraction comprising one or more of: dimethyl adipate or dimethyl glutarate.

5. The single-phase aqueous solution of claim 1, the organic ester fraction being present in a weight percent (w/w) with respect to the water of about 0.01% to 10%.

6. The single-phase aqueous solution of claim 1, further comprising a surfactant composition comprising at least one alkyl polyglycoside.

7. A method 100 for removing one or more coatings from a polymeric substrate using a single-phase aqueous solution, comprising:
102 providing a single-phase aqueous solution comprising water and an organic ester fraction comprising one or more alkyldioic acid dialkylesters;
104 providing a polymeric substrate, the polymeric substrate comprising one or more coatings; and
106 contacting the single-phase aqueous solution and the polymeric substrate to form a process mixture under conditions effective to remove a portion of the one or more coatings from the polymeric substrate.

8. The method of claim 7, the polymeric substrate comprising one or more of: polyethylene (PE), polypropylene (PP), polycarbonate (PC), acrylonitrile-butadiene-styrene (ABS), polycarbonate/acrylonitrile-butadiene-styrene (PC/ABS), polycarbonate/acrylonitrile-styrene-acrylate (PC/ASA), and a thermoplastic olefinic polymer.

9. The method of claim 7, the one or more coatings comprising one or more of: a paint, an ink, a dye, a powder coat, a paper label, a plastic label, an adhesive, a barrier coating, a metalized coating, and a bio-coating.

10. The method of claim 7, the conditions effective to remove a portion of the one or more coatings from the polymeric substrate comprising at least one of: heating the process mixture, agitating the process mixture, recovering the polymeric substrate after removal of a portion of the one or more coatings, or recovering at least a portion of the single-phase aqueous solution.

11. The method of claim 7, the conditions effective to remove a portion of the one or more coatings from the polymeric substrate comprising heating the process mixture at a temperature of about 60° C. to 100° C.

12. The method of claim 7, the providing the single-phase aqueous solution comprising providing the one or more alkyldioic acid dialkylesters in a weight percent (w/w) with respect to the water to form the single-phase aqueous solution, the weight percent being about 0.01% to 10%.

13. The method of claim 7, each dialkylester alkyl group of the one or more alkyldioic acid dialkylesters independently being C₁-C₄ alkyl.

14. The method of claim 7, the organic ester fraction comprising one or more of: dimethyl adipate or dimethyl glutarate.

15. The method of claim 7, the single-phase aqueous solution further comprising a surfactant composition comprising at least one alkyl polyglycoside.

16. A kit 200 for making a single-phase aqueous solution for removing one or more coatings from a polymeric substrate, comprising:
202 an organic kit component comprising one or more alkyldioic acid dialkylesters; and
204 instructions, the instructions directing a user to combine the organic kit component with water to form the single-phase aqueous solution.

17. The kit of claim 16, the instructions directing the user to : use the polymeric substrate comprising one or more of: polyethylene (PE), polypropylene (PP), polycarbonate (PC), acrylonitrile-butadiene-styrene (ABS), polycarbonate/acrylonitrile-butadiene-styrene (PC/ABS), polycarbonate/acrylonitrile-styrene-acrylate (PC/ASA), and a thermoplastic olefinic polymer;
and the polymeric substrate comprising one or more coatings comprising one or more of: a paint, an ink, a dye, a powder coat, a paper label, a plastic label, an adhesive, a barrier coating, a metalized coating, and a bio-coating.

18. The kit of claim 16, the instructions further directing the user to remove the one or more coatings from the polymeric substrate comprising the one or more coatings by at least one of:
heating the process mixture, agitating the process mixture, recovering the polymeric substrate after removal of a portion of the one or more coatings, and recovering at least a portion of the single-phase aqueous solution.

19. The kit of claim 16, the instructions directing the user to combine the organic kit component in a weight percent (w/w) with respect to the water to form the single-phase aqueous solution, the weight percent being about 0.01% to 10%.

20. The kit of claim 16, the organic kit component comprising one or more of: dimethyl adipate or dimethyl glutarate.

21. The kit of claim 16, the organic kit component further comprising a surfactant composition comprising at least one alkyl polyglycoside.
